(19) United States
(12) Patent Application Publication
(10) Pub. No.: US 2009/0206984 A1
(43) Pub. Date: Aug. 20, 2009

(54) APPLICATION CONTROL METHOD IN AN NFC CHIPSET COMPRISING SEVERAL HOST PROCESSORS

(75) Inventors: Bruno Charrat, Aix En Provence (FR); Philippe Martineau, Fuveau (FR)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: INSIDE CONTACTLESS, Aix-en-Provence Cedex 03 (FR)

(21) Appl. No.: 12/373,086

(22) PCT Filed: Jul. 3, 2007
(86) PCT No.: PCT/FR2007/001122

§ 371 Date: Mar. 30, 2009

(30) Foreign Application Priority Data
Jul. 10, 2006 (FR) 06 06288

(51) Int. Cl. G05B 19/00

(52) U.S. Cl. 340/5.2

(57) ABSTRACT

A method for controlling the execution of an application in a system having a contactless data sending/receiving interface (CLINT) of NFC type, and host processors (HP1, HP2, HP3) is described. Control of the execution of the application is based on control of an internal data path necessary for the transfer of the data of the application. The method includes requesting authorization for opening a data path to an application control function in response to a request (CMD) for using the data path in a non-open state, emitted by a source point (P1, P3) and designating a destination point (P1, P2, P3, Pc), and opening the data path to allow the application to be executed if the application control function so authorizes.

### CROSS-REFERENCE TO RELATED APPLICATIONS

This application is a Section 371 of International Application No. PCT/FR2007/001122, filed Jul. 3, 2007, which was published in the French language on Jan. 17, 2008, under International Publication No. WO 2008/006958 A2 and the disclosure of which is incorporated herein by reference.

### BACKGROUND OF THE INVENTION

Embodiments of the present invention relate to a method for controlling the execution of an application in a system having at least two host processors and one contactless data sending/receiving interface of Radio Frequency Identification (RFID) type, wherein one host processor is secured.

Embodiments of the present invention relates in particular to the implementation of a Near Field Communication (NFC) system.

NFC technology is currently developed by an industry consortium under the name of NFC Forum (http://www.nfc-forum.org). NFC Technology derives from the RFID technology and uses NFC components with several operating modes, i.e., a “Reader” mode, a “Card Emulation” mode, and a “Device” mode (also called “Device-to-Device” mode. In the reader mode, the NFC component operates as a conventional RFID reader to read or write access to an RFID chip (chip card or contactless tag). The NFC component emits a magnetic field, sends data by modulating the amplitude of the magnetic field, and receives data by charge modulation and inductive coupling. In the emulation mode, described by the commonly owned European patent EP 1 327 222, the NFC component operates passively like a transponder to engage in a dialog with another reader and to be seen by the other reader as an RFID chip. The NFC component does not emit a magnetic field, receives data by demodulating a magnetic field emitted by the other reader, and sends data by modulating the impedance of its antenna circuit (charge modulation). In the “Device” mode, the NFC component must match another reader also in the same operating mode, and each reader alternately enters a passive state (without field emission) to receive data and an active state (with field emission) to send data.

In addition to the three current operating modes (other operating modes may be utilized in the future), an NFC component can implement several contactless communication protocols and is, for example, able to exchange data according to the ISO 14443-A protocol, the ISO 14443-B protocol, the ISO 15693 protocol, or the like. Each protocol defines a transmit frequency of the magnetic field, a method for modulating the amplitude of the magnetic field to send data in active mode, and a method of charge modulation by inductive coupling to send data in passive mode. An NFC component is therefore a multimode and multiprotocol device. For example, the applicant markets an NFC component under the designation “MicroRead”.

Because of its wide communication capabilities, an NFC component is intended to be integrated into portable devices, such as mobile phones or Personal Digital Assistant (PDAS). Accordingly, FIG. 1 shows an NFC system, also called “NFC chipset,” that is a set of chips comprising an NFC component (referenced “NFCR1”) and at least one first host processor HP1.

“Host processor” designates any integrated circuit having a microprocessor or a microcontroller and which is connected to a port of the NFC component. In various applications, the NFC system also comprises a second host processor HP2.

It is to be noted that the host processors can be completely virtual and integrated in the NFC component itself.

The first host processor HP1 is the main processor of the device in which the NFC component is integrated, whereas the second host processor HP2 is a secured circuit. The host processor HP1 usually is a non-secured processor, for example the baseband circuit of a mobile phone (or radiotelephony circuit). The host processor HP2 is, for example, a Subscriber Identity Module (SIM) card (i.e., the microcontroller present in a SIM card). The resources of the NFC component are therefore put at the disposal of the processors HP1, HP2 to allow the processors HP1, HP2 to manage contactless applications. Such applications are shown in FIG. 2, which shows represents a mobile phone 30 equipped with the NFC system (chipset) of FIG. 1. These applications are: (1) Applications of AP1 type: the NFC component of the mobile phone 30 is in reader mode to read or write to a contactless integrated circuit CLCT. In this case, the mobile phone 30 is used as an RFID reader. This type of application can be free and may be utilized, for example, in reading advertising data inserted in a billboard of a bus shelter. The application can also be provided for a fee and be utilized, for example, in reading information reserved for subscribers. The application program AP1 is preferably held and executed by the processor HP1 if the service is free and is otherwise preferably held and executed by the processor HP2 because it requires the subscriber identification. Thus, as shown in FIG. 1, an application AP1 can be managed by the processor HP1 or the processor HP2. (2) Applications of AP2 type: the NFC component of the phone 30 is in card emulation mode to be read by conventional readers RD in payment or charged access applications (e.g., payment machine, metro entrance, or the like). The mobile phone 30 is therefore used like a chip card. The application program AP2 is preferably held and executed by the secured processor HP2, as shown in FIG. 1, because the access to the service requires the subscriber identification. (3) Applications of AP3 type: the NFC component of the phone 30 is in device mode and communicates with another device, for example a reader integrated in another mobile phone 31 or in a computer 32. This type of application is usually free and allows data packets to be transferred from one device to another (point-to-point file transfer in particular). The application program AP3 is preferably held and executed by the non-secured processor HP1, as shown in FIG. 1, which has a computing power higher than the secured processor HP2 when the processor HP2 is in a SIM card.

Thus, the implementation of an NFC system requires routing data flows between each processor HP1, HP2 and the NFC component (data sent via the contactless data transmission channel) and incoming data flows (data received via the contactless data transmission channel) between the NFC component and each processor HP1, HP2. Several disadvantages are evident as described below.

FIG. 3A schematically shows the architecture of the NFC component. The NFC component includes a contactless data sending/receiving interface CLINT equipped with an antenna circuit ACT, wire communication interfaces INT1, INT2 linked to the interface CLINT, and a controller NFCC. The interface INT1 is connected to the host processor HP1, and the interface INT2 is connected to the host processor HP2. The whole forms the NFC system (referred to as “CHIPSET”).

FIG. 3B schematically represents data flows which must be routed so that the resources of the contactless data sending/receiving interface CLINT can be used by each processor HP1, HP2. For the sake of simplicity, the interface CLINT is assumed to be able to send or receive data according to three protocols PT1, PT2, PT3 only, for example ISO 14443-A, ISO 14443-B, and ISO 15693, and has the three aforementioned operating modes M1, M2, M3 (reader mode, emulation mode, and device mode). Four different types of data flows are thus distinguished: (1) an outgoing data flow DT1out (Mi, PTi) from a source point P1 located in the processor HP1, transmitted to a destination point Pc located in the interface CLINT, and transmitted by the interface in a contactless data transmission channel created according to a protocol PTi (PT1, PT2 or PT3) and an operating mode Mi (M1, M2 or M3); (2) an outgoing data flow DT2 out(Mi, PTi) from a source point P2 located in the processor HP2, transmitted to a destination point Pc located in the interface CLINT, then transmitted by the interface CLINT via a contactless data transmission channel created according to a protocol PTi and an operating mode Mi; (3) an incoming data flow DT1in(Mi, PTi) received by the interface CLINT via a contactless data transmission channel created according to a protocol PTi and an operating mode Mi, then transmitted by the interface CLINT from a source point Pc to a destination point P1 located in the processor HP1; and (4) an incoming data flow DT2 in(Mi, PTi) received by the interface CLINT via a contactless data transmission channel created according to a protocol PTi and an operating mode Mi, then transmitted by the interface CLINT from a source point Pc to a destination point P2 located in the processor HP2.

As each outgoing data flow can be emitted in three operating modes M1, M2, M3 and according to three protocols PT1, PT2, PT3, it follows that nine different configurations are possible for each outgoing data flow (assuming that each mode Mi and protocol PTi combination is authorized). It is therefore insufficient that one processor HP1 or HP2 forwards the data to be sent to the interface CLINT. The processor HP1 or HP2 must also specify, for each data string sent, the mode/protocol Mi/PTi configuration to be used by the interface CLINT to transmit the data in a contactless data transmission channel.

To allow outgoing data to be routed while allowing the interface CLINT to be configured in an adapted way, it has been suggested to provide a data transfer protocol HCI (“Host Controller Interface”) of “universal” type, enabling any type of host processor to supply data to be sent to the interface CLINT, while specifying the configuration to be used (protocol PTi and operating mode Mi) to transmit the data in the contactless communication channel. Such a protocol HCI provides data frames, each data frame having header fields and data fields. The data fields include the information necessary for the control of the interface CLINT, in particular, fields specifying data start and destination points, the operating mode, and the protocol to be used by the interface CLINT.

It is therefore desirable to control data flows between the non-secured processor HP1 of the NFC system and the source or destination point Pc (i.e., contactless data sent or received via the interface CLINT). Such data flows correspond to NFC applications that service providers want to control with a view to a commercial exploitation, in spite of the fact that the processor HP1 is not secured. Preferentially, it is also desirable to control data flows between the non-secured processor HP1, other secured processors that may be part of the system, and the interface CLINT.

In addition, the conventional protocol HCI provides data frames with long and complex header fields, requiring a considerable processing time before processing the actual data. This problem is called “overheading,” which means that long frame headers overload data flows and affect data transmission time. Such large header fields moreover require buffers of great size and a high computing power.

Thus, it is further desirable to provide a data routing process in an NFC system which is easy to implement and does not require large header fields.

### BRIEF SUMMARY OF THE INVENTION

According to one embodiment of the invention, control of the execution of an application in a system comprising a contactless data sending/receiving interface of NFC type is based on control of a data path internal to the system, necessary to the transfer of data of the application. The method includes, in response to a request for using the data path in a non-open state, emitted by a source point and designating a destination point, requesting authorization to open the data path to an application control function. The method further includes opening the data path if the application control function authorizes the opening of the data path, in order to allow the application to be executed.

According to one embodiment of the invention, the system includes a first host processor executing the application control function.

According to one embodiment of the invention, the first host processor is a secured circuit.

According to one embodiment of the invention, the first host processor is an integrated circuit of a SIM card.

According to one embodiment of the invention, the system includes at least a second host processor executing the application.

According to one embodiment of the invention, the method includes a preliminary step of authentication of the application control function, performed before the step of requesting authorization. The opening of the data path is not authorized if the application control function has not been authenticated.

According to one embodiment of the invention, the method includes supplying to the application control function a session key, which is used to cipher the data exchanged with the application control function, if the application control function has been authenticated.

According to one embodiment of the invention, the method includes authenticating, by the application control function, of the source point that has emitted the request for using the data path. The application control function authorizes the opening of the data path only if the authentication has succeeded.

According to one embodiment of the invention, authentication of the source point which emitted the request for using the data path includes a step of checking a certificate supplied by a certification authority to a host processor in which the source point to be authenticated is located.

According to one embodiment of the invention, the opening of the data path includes allocating a routing channel number to the data path and storing the routing channel number and routing parameters comprising at least one identifier of the source point and one identifier of the destination point, sending to the destination point data supplied by the source point by encapsulating the data in a frame having a header field including the routing channel number, and upon receiving data encapsulated in a frame having a header field including the routing channel number, transmitting the data toward the data destination point corresponding to the identifier of the destination point memorized.

According to one embodiment of the invention, the application control function authorizes or does not authorize the opening of a data path according to the routing parameters of the data path to be opened.

According to one embodiment of the invention, the sending/receiving interface is configurable according to a predetermined number of operating modes and according to a predetermined number of contactless communication protocols. The application control function authorizes or does not authorize the opening of a data path according to the operating mode and the communication protocol of the data path to be opened.

According to one embodiment of the invention, the method includes, in response to an authorization for opening the data path between a source point and a destination point located in the contactless data sending/receiving interface, opening a data path between the source point and the sending/receiving interface so that data is emitted in a contactless data transmission channel using operating mode and contactless communication protocol parameters stored for the data path through which the data to be emitted has been received.

According to one embodiment of the invention, the method includes the simultaneous opening of a predetermined number of data paths. The routing channel number and the routing parameters of each open data path are stored in a routing table. The method includes searching the routing table for a destination point of received data encapsulated in a frame using the routing channel number as an index for selecting the destination point.

According to one embodiment of the invention, the method includes prestoring data paths in a routing table. Each data path includes an identifier of a destination point, an operating mode parameter of the sending/receiving interface, a contactless communication protocol parameter, and a data path open/closed indicator. When data is received by the sending/receiving interface via a contactless data transmission channel, the method also includes determining at least one data destination point by searching the routing table for an open data path having an operating mode parameter and a contactless communication protocol parameter corresponding to the operating mode and contactless communication protocol parameters used by the sending/receiving interface to create the contactless data transmission channel through which data is received.

Embodiments of the present invention also relate to a device for controlling the execution of an application in a system having a contactless data sending/receiving interface of NFC type, driven by a controller.

According to one embodiment of the invention, the control of the execution of an application is based on a control of a data path internal to the system, necessary for the transfer of data of the application. The controller is configured to, in response to a request for using the data path in a non-open state, emitted by a source point and designating a destination point, request authorization to open the data path to an application control function, and open the data path if the application control function authorizes the opening of the data path, in order to allow the application to be executed.

According to one embodiment of the invention, the system having at least a first host processor executing the application control function, and at least one input/output port to link the sending/receiving interface to the host processor.

According to one embodiment of the invention, the host processor executing the application control function is a secured integrated circuit.

According to one embodiment of the invention, the host processor executing the application control function is an integrated circuit of a SIM card.

According to one embodiment of the invention, the system includes at least one second host processor executing the application.

According to one embodiment of the invention, the controller is configured to authenticate the application control function before performing the authorization request. The opening of the data path is not authorized if the application control function has not been authenticated.

According to one embodiment of the invention, the controller is configured to supply to the application control function a session key which is used to cipher the data exchanged between the controller and the application control function, if the application control function has been authenticated.

According to one embodiment of the invention, the controller is configured to transmit authentication data exchanged between the application control function and the source point which has emitted the request for using the data path. The application control function authorizes the opening of the data path only if the authentication has succeeded.

According to one embodiment of the invention, the authentication data exchanged between the application control function and the source point which has emitted the request for using the data path includes a certificate supplied by a certification authority to a host processor in which the source point to be authenticated is located.

According to one embodiment of the invention, the controller is configured to allot a routing channel number to the data path, and store the routing channel number and routing parameters comprising at least one identifier of the source point and one identifier of the destination point, send to the destination point data supplied by the source point by encapsulating the data in a frame having a header field including the routing channel number, and upon receiving data encapsulated in a frame having a header field including the routing channel number, transmit the data to the data destination point corresponding to the identifier of the stored destination point.

According to one embodiment of the invention, the controller is configured to authorize or deny the opening of a data path according to the routing parameters of the data path to be opened.

According to one embodiment of the invention, the contactless data sending/receiving interface is configurable according to a predetermined number of operating modes and according to a predetermined number of contactless communication protocols. The application control function is configured to authorize or deny the opening of a data path according to the operating mode and the communication protocol of the data path to be opened.

According to one embodiment of the invention, the controller is configured to, in response to an authorization for opening the data path between the source point and designating a destination point located in the contactless data sending/receiving interface, open a data path between the source point and the destination point by configuring the sending/receiving interface to emit data in a contactless data transmission channel using the operating mode and contactless communication protocol parameters stored for the data path to be opened.

According to one embodiment of the invention, the controller is configured to simultaneously open a predetermined number of data paths, the routing channel number and the routing parameters of each open data path being stored in a routing table, and search the routing table for a destination point of the received data encapsulated in a frame, by using the routing channel number as an index for selecting the destination point.

According to one embodiment of the invention, the data transmission function is configured to prestore data paths in a routing table. Each data path includes an identifier of a destination point, an operating mode parameter of the sending/receiving interface, a contactless communication protocol parameter, and a data path open/closed indicator. When data is received by the sending/receiving interface via a contactless data transmission channel, the data transmission function is also configured to determine at least one data destination point by searching the routing table for an open data path having an operating mode parameter and a contactless communication protocol parameter corresponding to the operating mode and contactless communication protocol parameters used by the sending/receiving interface to create the contactless data transmission channel through which the data is received.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1, previously described, shows in block form a conventional architecture of an NFC system and contactless circuits with which the NFC system can communicate;

FIG. 2, previously described, shows various applications of an NFC system integrated in a mobile phone;

FIG. 3A, previously described, shows in block form the conventional architecture of an NFC component present in the NFC system of FIG. 1;

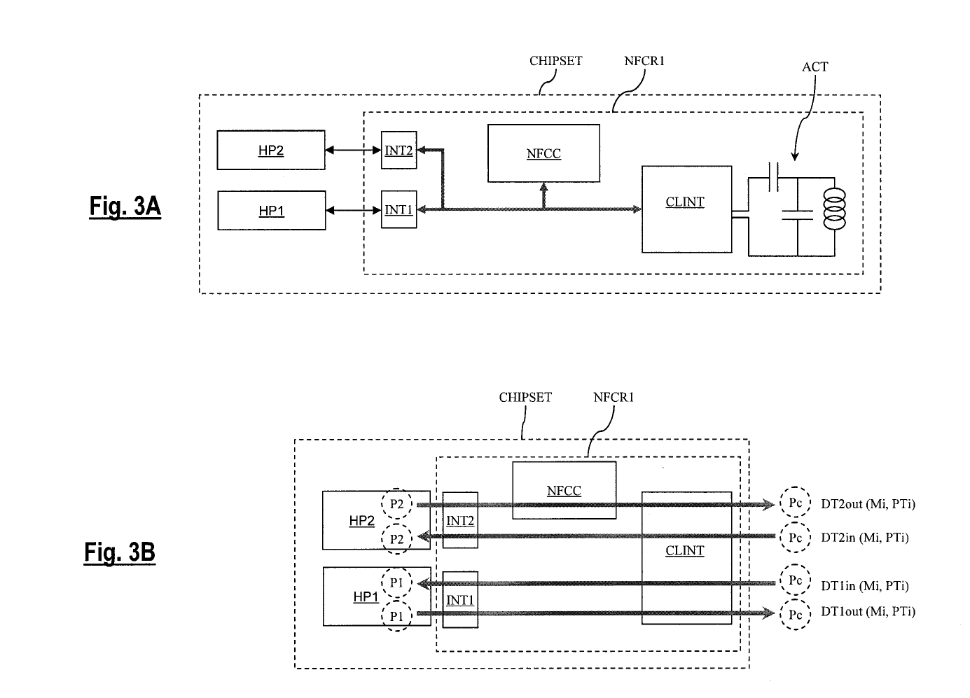

FIG. 3B, previously described, shows data flows crossing the NFC system and corresponding to various applications;

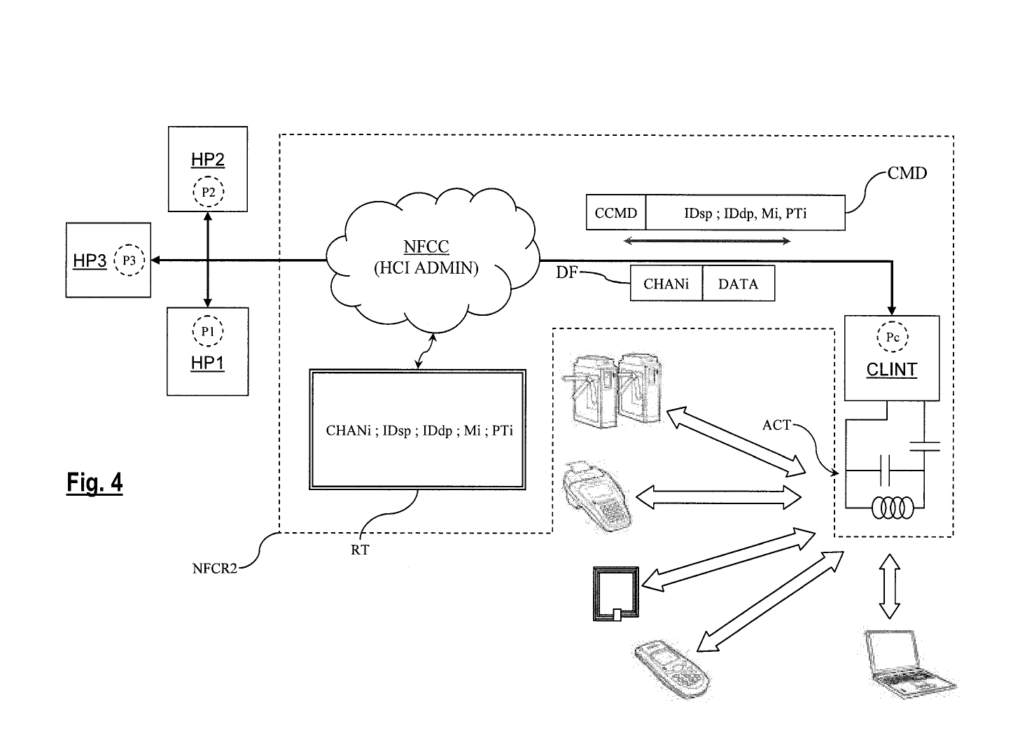

FIG. 4 schematically shows the implementation of the routing process according to embodiments of the invention in an NFC system;

FIGS. 5 to 7 show sequences of data exchange between processors of the NFC system;

FIG. 8 shows an example of hardware architecture of an NFC component present in the NFC system of FIG. 4; and

FIG. 9 shows an example of software architecture of the NFC component of FIG. 8.

### DETAILED DESCRIPTION OF THE INVENTION

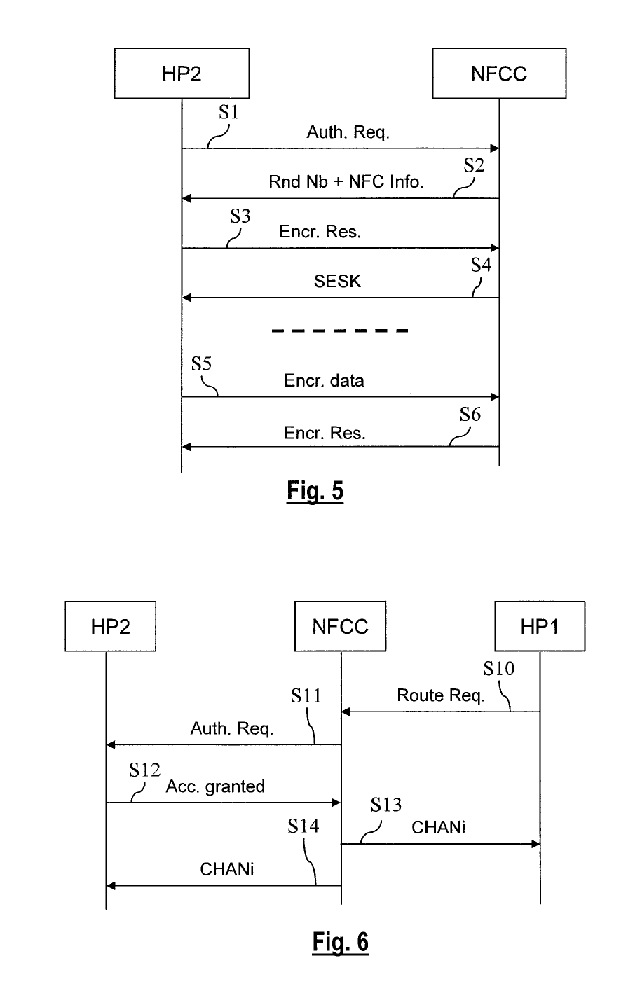

FIG. 4 schematically shows the implementation of a method for opening a data path according to the invention. The method is implemented in an NFC system having an NFC component referenced “NFCR2” and host processors HP1, HP2, HP3. The component NFCR2 includes the same parts as the component NFCR1 described above, in particular a controller NFCC and a contactless data sending/receiving interface CLINT equipped with an antenna circuit ACT. For the sake of simplicity, the interface CLINT is from now on assumed to be able to send or receive data only according to three protocols PTi, i.e., protocol PT1 (ISO 14443-A or “ISOA”), protocol PT2 (ISO 14443-B or “ISOB”), and protocol PT3 (ISO 15693 or “ISO15”). The interface has in addition the three aforementioned operating modes Mi, i.e., M1 (reader mode), M2 (card emulation mode), and M3 (device mode).

Source or destination points of a data flow in the NFC system are designated P1 (point located in the host processor HP1), P2 (point located in the host processor HP2), P3 (point located in the host processor HP3), and Pc (point located in the contactless interface CLINT).

For example, the host processor HP1 is the main processor of the system in which the NFC component is integrated. It is a non-secured processor, i.e., not including usual cryptography and authentication circuits of secured processors. The host processor HP2 and the host processor HP3 are here secured circuits, such as a SIM card and a credit card chip.

According to an embodiment of the invention, one secured host processor of the NFC system, for example HP2, is used to authorize or deny the opening of a data path according to parameters such as the protocol PTi, the operating mode Mi, and the identifiers of the source and destination points of the data path.

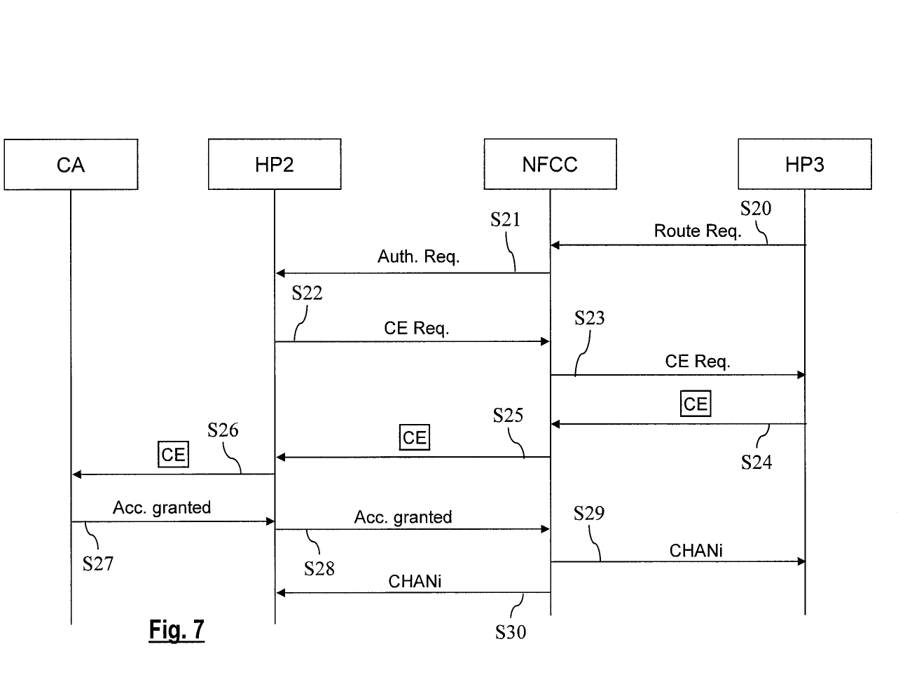

FIG. 5 shows various steps of an authentication sequence executed by the secured host processor HP2 and the controller NFCC at the initialization of the NFC system.

During a first step S1, the processor HP2 emits an authentication request to the controller NFCC. At the following step S2, the controller NFCC answers the request by supplying a random number Rnd Nb and information NFC Info, regarding the NFC component (for example a serial number, a manufacturing date, a number of software version, or the like). At the following step S3, the processor HP2 uses an encryption key shared with the host processor HP2 to cipher the random number received, and possibly the other information received, and sends the ciphered data to the controller NFCC.

At the following step S4 the controller NFCC considers the processor HP2 as being authenticated if it has succeeded in deciphering the information received from the processor HP2 using the encryption key it shares with the authorized secured processors. If such is the case, the controller NFCC sends to the processor HP2 a notification message that the processor HP2 was authenticated and includes a session key SESK. If the processor HP2 is not authenticated, the controller NFCC refuses any further communication therewith.

If the processor HP2 has been authenticated, the controller NFCC and the processor HP2 may exchange configuration and management information under a ciphered form, enabled by the session key SESK (steps S5 and S6). On the contrary, if the processor HP2 has not been authenticated by the controller NFCC, the controller systematically refuses to open data paths.

The actual creation of a data path or routing channel is performed by the controller NFCC as administrator Host Computer Interface (HCI) (“HCI ADMIN”). When a command for creating a data path is received (e.g., command “Creation of a route”) and is allowable, the controller NFCC allots a routing channel number CHANi to the data path and sends a confirmation message to the entity that has emitted the command.

More particularly, the controller NFCC is used as an administrator of a protocol HCI according to embodiments of the invention which have the following features: (i) the use of commands CMD allowing a data path (routing channel) to be managed, in particular commands for opening and closing data paths, and (ii) the use of data frames DF including a header field of short length and a data field (DATA), the header field including a routing channel number CHANi.

Examples of routing commands and examples of data frames are described in Annex 1 which is an integral part of the description. For the sake of simplicity, all of the commands that can be provided will not be described here. Annex 1 describes essential commands of route creation, route modification and route suppression, and the answers to such commands (confirmation or error messages). Annex 1 also describes the format of data frames DF, which advantageously has a header field of small size, such as only 8 bits.

The commands for opening, closing, or modifying a data path are emitted by one of the host processors HP1, HP2 or by the interface CLINT and are processed by the controller NFCC. The commands specify the operating mode Mi and the protocol PTi of the interface CLINT for the data path concerned. If the opening of a data path is requested by one of the host processors HP1 or HP2, the mode Mi and the protocol PTi appearing in the command are used by the controller NFCC to configure the interface CLINT with regard to the contactless communication channel that the interface CLINT must create to send the data that will be received via the data path. If the opening of a data path is requested by the interface CLINT, the operating mode Mi and the protocol PTi specified in the command emitted by the interface CLINT are informative and specify the conditions of operating mode and protocol in which the interface CLINT has received the data for transmission in the data path.

It is to be noted that a command for transmitting data by a non opened data path can also trigger a procedure for opening the data path with a previous authorization request.

FIG. 6 shows steps S10, S11, S12, S13, S14 of a general sequence for opening a data path. The sequence can only be executed if the controller NFCC has previously authenticated the host processor HP2.

At step S10, a host processor, for example HP1, requests authorization from the controller NFCC to open a data path. To that end, the processor HP1 supplies information relating to the data path to be opened. The information notably includes the protocol PTi and the transmission mode Mi of the data path to be opened, as well as identification information relating to the source and destination points of the data path.

At step S11, the controller NFCC requests authorization to open the data path to the processor HP2. According to the information received relating to the path to be opened, the processor HP2 authorizes or denies the requested opening of the path. For example, in some operating modes, the processor HP2 can systematically authorize or refuse the opening of a data path.

At step S12, the processor HP2 authorizes the opening of the data path by supplying a channel identifier CHANi to the controller NFCC. At the following steps S13 and S14, the channel identifier CHANi allotted to the data path is supplied by the controller NFCC to the processor HP1 and HP2. If the opening of the data path requested is refused, the processor HP2 notifies the controller NFCC, which sends a message of refusal of channel opening to the processor HP1.

Thus, the conduct of any application corresponding to a determined data path can be controlled by the (or a) secured processor. For example, applications requiring use of the non-secured host processor HP1 (for example, applications of contactless reading of video files in public places of sale, requiring the computing power of the processor HP1), can be controlled by the access providers. It is the same for applications managed by a processor such as the processor HP3 that, although secured, is not allotted to security control within the NFC system and is thus submitted to the arbitration of the secured processor HP2.

FIG. 7 shows another example of a sequence of opening of a data path according to embodiments of the invention, including steps S20 to S30. The sequence shown in FIG. 7 includes a certificate CE supplied by a certification authority CA. This sequence is adapted in particular to the services for which access is not free.

As previously described, the processor HP3 emits a request for opening a data path (step S20). This request is transmitted by the controller NFCC to the processor HP2 (step S21). The processor HP2 emits a certificate request (step S22) in response. The request is redirected by the controller NFCC to the processor sender of the request for data path opening, i.e., the processor HP3 (step S23). At the following step S24, the processor HP3 emits in response the certificate CE requested, which is successively redirected by the controller NFCC (step S25), and by the processor HP2 to the certification authority CA (step S26). The communication link between the authority CA and the processor HP2 depends on the nature of the NFC system or of the system to which the NFC system is connected. If the system is a mobile phone, the link can be established in a mobile network, such as Global System for Mobile Communications (GSM).

At the following step S27, the certification authority CA recognizes or denies the authenticity of the certificate CE received. If the certificate CE received is authentic, the authority CA sends to the processor HP2 a message indicating that the access requested is authorized and indicates, if necessary, an amount to be paid for the access requested. At the following step S28, the processor HP2 informs the controller NFCC that the requested opening of the data path is authorized. The controller NFCC then supplies a channel number CHANi to the processor HP3 (step S29) and to the processor HP2 (step S30).

The sequence illustrated by FIG. 7 can be applied, for example, to the purchase of the access to a service by a user. The processor HP2 authorizes the creation of a data path between the interface CLINT and the processor HP1 when the interface CLINT receives data in device mode ISO B.

It is to be noted that all the information exchanged between the controller NFCC and the processor HP3 can be ciphered using the session key SESK transmitted at step S4 (FIG. 5).

The processor HP2 does not necessarily need to address a certification authority CA. In some applications, the processor HP2 may check a certificate itself. Before authorizing the opening of a path, it can also be provided that the processor HP2 authenticates the processor HP3 by checking that the processors HP2 and HP3 share an identical secret key (steps S2 to S4 of FIG. 5).

Thanks to theses provisions, an operator who assigns SIM cards to users can thus control the access to services using the system, independently of the operators that provide the services.

Alternately, authentication of the host processor HP3 by the host processor HP2 can be previously performed, for example, during initialization of the system. The host processor HP2 authorizes the opening of a data path only if the host processor HP3 that has emitted the opening request has been previously authenticated.

The control of a data path to implement certain embodiments of the invention can be performed by any conventional techniques, for example, using multiplexing circuits or logic gates controlled by signals supplied by the NFC processor upon authorization of the secured processor. However a routing method will be described hereinafter, which allows data paths to be simply, rapidly, and efficiently controlled.

According to one embodiment of the invention, the controller NFCC of the NFC component further undertakes the management of a routing table RT in which data paths are stored. Each data path is identified by a routing channel number CHANi.

The data paths stored in the routing table differ from one another at least by the following parameters:
CHANi; IDsp; IDdp; Mi, PTi
   where CHANi is the routing channel number allotted to the data path, IDsp is an identifier of the data path source point, IDdp is an identifier of the data path destination point, and Mi and PTi are the operating mode and the contactless communication protocol used by the interface CLINT to send or receive data via a contactless data transmission channel.

Each time the controller NFCC allots a routing channel number CHANi to a data path, it registers the parameters IDsp, IDdp, Mi, PTi indicated in the command in the routing table RT.

An example of a routing table RT created by the controller NFCC is described by Table 1, in Annex 2, which is an integral part of the description. The routing table RT is created after receiving a series of commands for opening paths having source points located in one of the processors HP1 or HP2 (i.e., a source point P1 or P2). Optionally, the controller can define a secondary destination point intended to receive copy of data circulating in the data path. The secondary destination point or notification point is determined by the controller from a notification table (not shown) which indicates thereto the data paths for which the data must be notified to the other host processor. Although shown statically in Table 1, the routing table RT is dynamic and is updated in real time according to the creation, modification, or suppression commands received by the controller NFCC.

In one embodiment, the routing table RT is static and has been prestored by the controller NFCC, for example, upon request of one host processor and at the powering of the system. Table 2 in Annex 2 describes an example of prestored routing table RT which source points are the points P1, P2 or P3 located in the host processors HP1, HP2, HP3. The channel number CHANi can also be prestored in the table for each conceivable routing configuration. In such a prestored table, a field “Busy” and “Open” or “Authorized” is provided in each row of the table (one row corresponds to one routing channel). The controller NFCC registers the value “1” in the field “Open” when it opens the corresponding data path, and registers the value “0” in response to a command for closing the data path. When a data path is in use, the controller NFCC registers the value “1” in the field “Busy”.

The transmission of the data received in the data frames is also under the control of the controller NFCC, which refers to the routing table RT to determine the destination points of the data. Advantageously, as it appears in the format of data frames described in Annex 1, it is not necessary for the source point which sends the data to the processor to specify all of the parameters of the routing channel used. The header field of the data frame may simply include parameterizing bits T and L and 6 bits of channel number (allowing 63 data paths to be simultaneously routed, the channel “0” being reserved for the protocol HCI administration).

Thus, upon reception of a data frame, the controller NFCC sends data back to the destination point designated in the routing table RT, using the channel number as an index to find this destination point in the routing table RT (as well as possibly the notification point). If the destination point is the point Pc (interface CLINT), the controller NFCC undertakes parametrizing the interface CLINT so that it sends the data in a contactless data transmission channel in accordance with the information of contactless protocol PTi and operating mode Mi appearing in the routing table RT. In another embodiment, the interface CLINT undertakes its own parametrizing by reading the routing table RT when data is received in a data frame (which requires that a part of the controller NFCC attributions be transferred to the interface CLINT).

Thus, the routing table RT allows the interface CLINT to be parameterized without requiring inclusion of the operating mode Mi and contactless communication protocol PTi parameters in the headers of data frames. The routing table RT is therefore not a simple routing table in the conventional meaning of the term, but also forms a parametrizing table.

Table 3 of Annex 2 describes an example of a dynamic routing table RT having data paths created upon request of the interface CLINT (having Pc as a source point). As previously indicated, the problem raised by incoming data routing (data received via a contactless communication channel) is that the interface CLINT and the controller NFCC do not necessarily know which host processor receives the data. Consequently, the routing table created by the controller NFCC upon request of the interface CLINT indicates that the data must be sent to the two destination points P1, P2, P3 located in the host processors HP1, HP2, HP3, and the host processor which is not concerned with the data is responsible for not responding and notifying the other host processor to send response data to the interface CLINT.

It will be noted here that the data paths created upon request of one host processor HP1, HP2, HP3 or upon request of the interface CLINT are preferably bi-directional. Thus, for example, once a data path has been created by a point P1 located in the processor HP1 to send data in a contactless communication channel defined by the mode parameter M2 and the protocol PT2, all of the data received by the interface CLINT in the mode M2 and according to the protocol PT2 will be sent in this data path and will therefore be received by the point P1. Those skilled in the art will also note that the provision of bi-directional data paths imposes managing possible conflicts, by forbidding two bi-directional paths having different source and/or destination points to use the same mode Mi and protocol PTi parameters for the interface CLINT. For example, the routing table RT described by Table 1 shows data paths that cannot coexist (for example, channel 1 and channel 9, these data paths are described in the same table only by way of illustration).

When incoming data is received, the contactless data sending/receiving interface CLINT and the controller NFCC do not necessarily know which host processor receives the data. Consequently, in prior systems, the data was sent to both processors, and the intended processor was responsible for not responding.

International application WO 2004/029860 proposes a routing method which calls for using, for purposes of routing incoming data, the field Application Protocol Data Unit (APDU) located in the commands received via the contactless data transmission channel. However, the method requires new protocols to be developed to implement routing, meaning that the external element sending data in the contactless data transmission channel must specify for which internal element (which host processor) the data is intended.

In various applications, the external element sending data is not designed to give routing indications to know which processor receives the data. Routing is an internal problem linked to the fact that several processors of the same NFC system share the same contactless data sending/receiving interface. It is therefore not likely that a universal routing protocol should be integrated in the near future into devices not complying with an NFC standard. For example, a conventional reader used for access payment or control sends commands for secret code authentication and/or checking to contactless chip cards. During an authentication, such a reader does not know if it communicates with a true contactless card or with an NFC component in card emulation mode. Consequently, such a reader is not designed to emit parameters allowing the application data it sends to be routed inside the NFC system.

The host processor(s) present in an NFC system are “specializing” some applications or application types according to their nature (secured or not, SIM card processor or Baseband processor), their computing power, and the processing units they comprise. Among the various applications an NFC system can be brought to manage, each application or application type generally corresponds to a determined operating mode of the contactless data sending/receiving interface CLINT and to a determined contactless communication protocol (PT1, PT2, PT3).

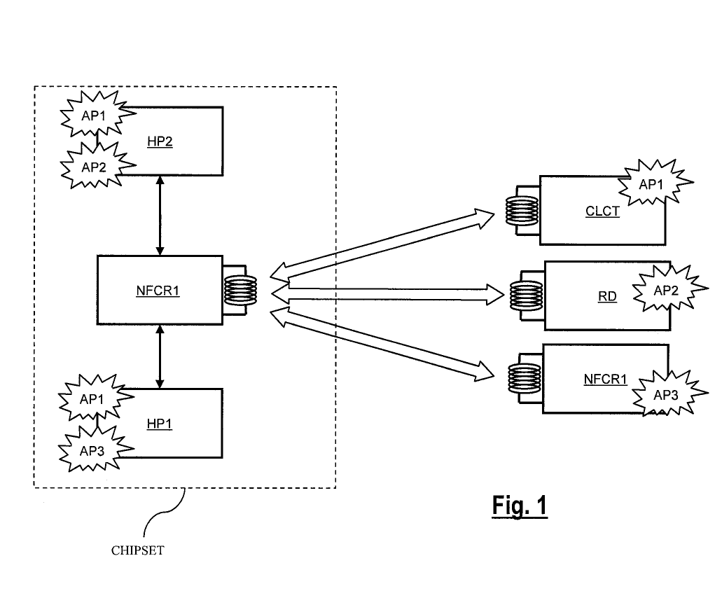

Consequently, a combination of an operating mode Mi of the interface CLINT and a protocol PTi can correspond to an application type which is intended to be managed by a particular host processor. That appears in FIG. 1 where secured applications AP2 in emulation mode are usually managed by a SIM card (processor HP2), and non-secured applications of AP3 type (for example, point-to-point file transfer) are preferably managed by the Baseband processor because of its higher processing power and of the transfer not being secure. In addition, the secured applications in emulation mode are usually based on the protocols ISOA and ISOB, whereas the mode ISO 15693, offering a longer communication distance, is preferably intended for non-secured applications generated by the host processor HP 1 and not by the host processor HP2, if it is a SIM card.

Thus, according to embodiments of the invention, rules for incoming data routing are predefined according to the operating mode Mi of the interface CLINT and the contactless communication protocol PTi according to which data is received. The predetermined routing rules are, for example, the following (these examples are not limited):

i) when the interface CLINT receives data in reader mode ISO A, the data is sent in priority to the host processor HP1 and is notified to the host processor HP2;

ii) when the interface CLINT receives data in reader mode ISO B, the data is sent in priority to the host processor HP1 and is notified to the host processor HP2;

iii) when the interface CLINT receives data in reader mode ISO 15693, the data is sent in priority to the host processor HP2 and is not notified to the host processor HP1;

iv) when the interface CLINT receives data in card emulation mode ISO A, the data is sent in priority to the host processor HP2 and is not notified to the host processor HP1;

v) when the interface CLINT receives data in card emulation mode ISO B toward host processor HP1, the data is sent in priority to the host processor HP1 and is not notified to the host processor HP2;

vi) when the interface CLINT receives data in card emulation mode ISO 15693, the data is only notified to the host processor HP2 and is neither sent nor notified to the host processor HP1;

vii) when the interface CLINT receives data in device mode ISO A (matching managed by the host processor HP1), the data is sent in priority to the host processor HP1 and is notified to the host processor HP2; viii) when the interface CLINT receives data in device mode ISO B, the data is blocked (no action); and

ix) when the interface CLINT receives data in device mode ISO 15693 (matching managed by the host processor HP1), the data is sent in priority to the host processor HP1 and is notified to the host processor HP2.

This set of rules allows a routing table RT of incoming data to be defined, as described by Table 4 in Annex 2. The routing table RT is static and is prestored by the controller NFCC, for example, upon request of the secured processor HP2 and when powering up the NFC system. The table RT is preferably modified in real time.

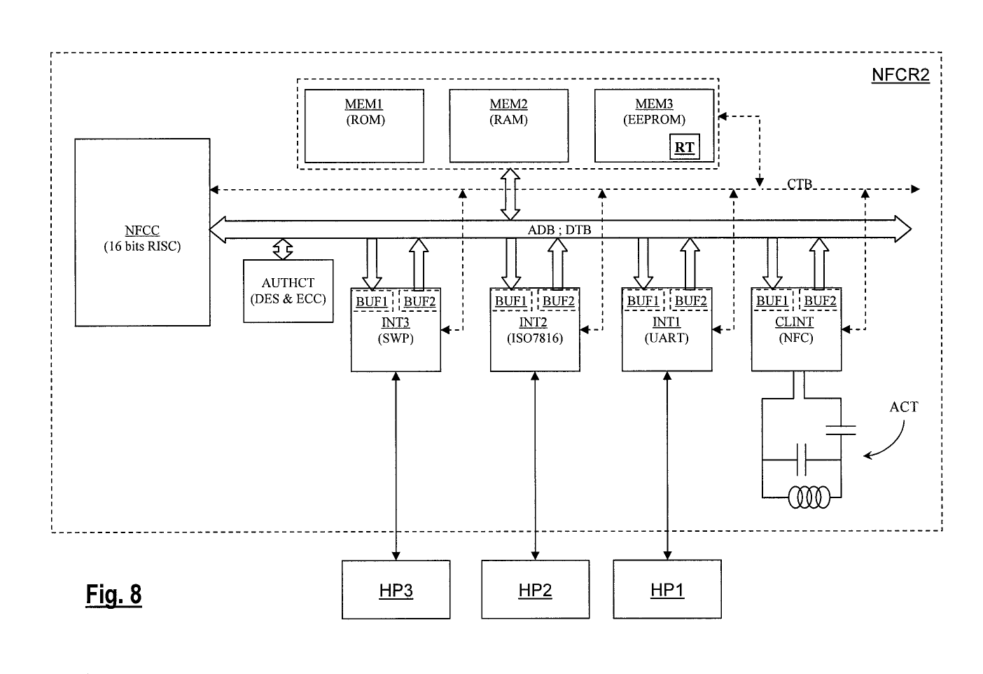

FIG. 8 shows an example of hardware architecture of the component NFCR2 of FIG. 4. The component NFRC includes the controller NFCC and the interface CLINT already described; a memory array having a program memory MEM1 of Read Only Memory (ROM) type, a data memory MEM2 of Random Access Memory (RAM) type, and an electrically erasable and programmable memory MEM3 of EEPROM type in which the routing table RT is stored; an authentication and error correction circuit AUTHCT comprising Data Encryption Standard (DES) and Elliptic Curve Cryptography (ECC) algorithms, or other cryptography algorithms; a connection port INT1 of Universal Asynchronous Receiving Transmitting (UART) type to which the host processor HP1 is connected; a connection port INT2 of ISO7816 type to which the host processor HP2 is connected (the processor HP2 here is assumed to be a SIM card); a connection port INT3 of Single Wire Protocol (SWP) type allowing the host processor HP3 to be connected; a data bus DTB and an address bus ADB linking the memory array, the controller NFCC, the interface CLINT and the ports INT1, INT2, INT3; and a control bus CTB allowing the various elements to be controlled and read and/or write accessed by the controller NFCC.

The interface CLINT and the ports INT1, INT2, INT3 each include an input buffer BUF1 at a parallel input and an output buffer BUF2 at a parallel output that is respectively read and write accessible via the data bus DTB and the address bus ADB. The exchange of data forming the routing commands or the data frames between the host processors HP1, HP2, HP3 and the controller NFCC or the interface CLINT is thus performed by data blocks the size of buffers BUF1, BUF2, and is clocked by the controller NFCC.

It is to be noted that the routing table RT is only accessible by the controller NFCC. Consequently, the routing table RT can only be modified if the host processor HP2 is authenticated by the controller NFCC.

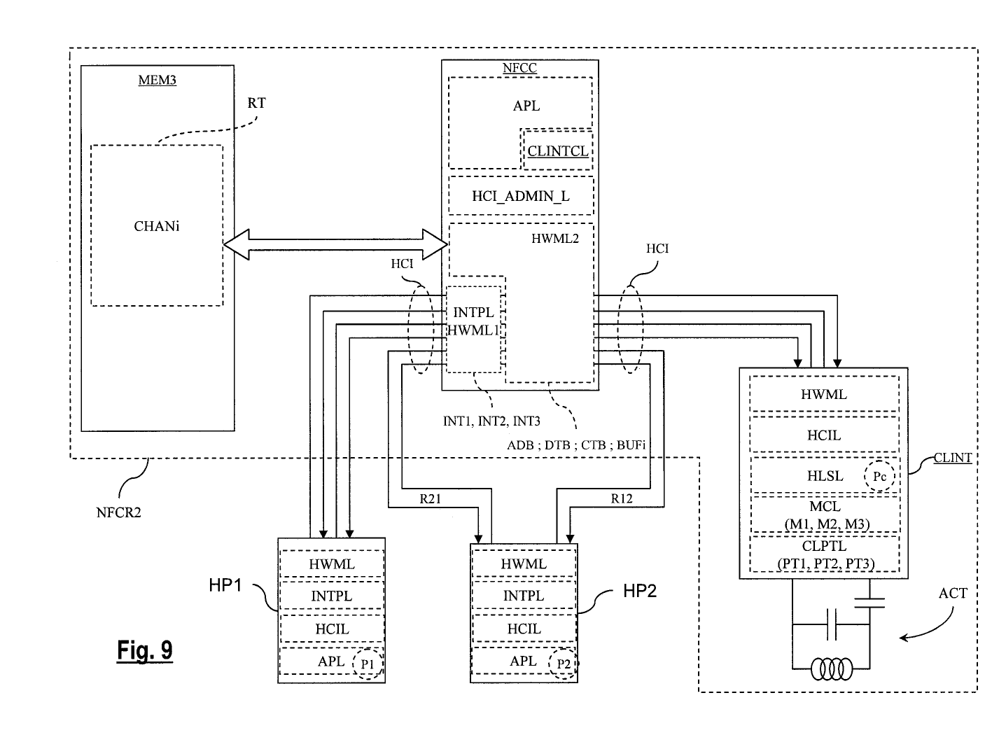

FIG. 9 shows an example of software architecture of the component NFCR2 and host processors HP1, HP2. The software architecture includes, for the NFC component and the host processors of the system, several software layers going from the lowest level (data link layer) to the highest level (application layer). The representation of these software layers in FIG. 9 is simplified in relation to the real software architecture of a NFC system according to embodiments of the invention but is sufficient for those skilled in the art desiring to implement embodiments of the invention as described.

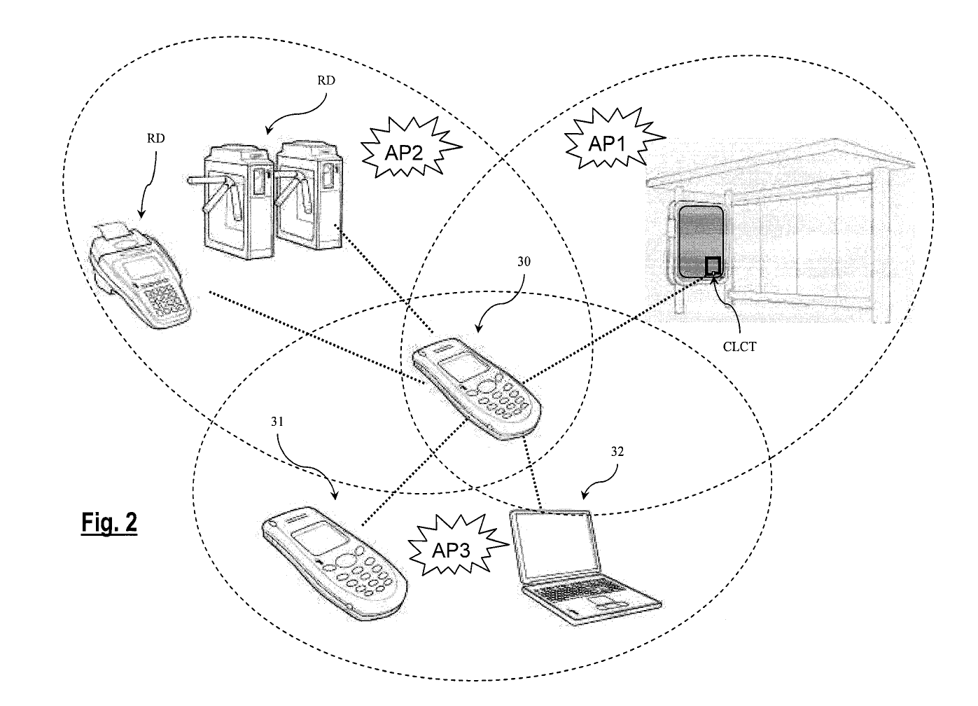

Each host processor HP1, HP2 includes at least four software layers, in an ascending order of levels. A low level Hardware Management Layer (HWML) manages the operation of hardware elements, allowing the host processors to exchange data with the controller NFCC. The HWML is, for example, the interface management layer UART for the processor HP1 and the interface management layer ISO7816 for the processor HP2. An Interface Protocol Layer (INTPL) manages the protocol of the communication ports INT1, INT2, INT3. The INTPL is, for example, the protocol management layer UART for the processor HP1 and the protocol management layer ISO7816 for the processor HP2. An HCI Layer (HCIL) manages the protocol HCI according to the invention, i.e., that manages the creation of a communication channel by generating the commands described above and in Annex 1 and by processing the answer messages to such commands. This layer is based on the INTPL and HWML layers which are nearly transparent to it. A high level Application Layer (APL) manages the RFID applications like those shown in FIGS. 2 and 4 (reading of a chip card or an electronic tag, emulation of a chip card, dialog in device-to-device mode with an external processor to exchange files, or the like). This layer can include several application programs, each being secured or unsecured (according to the internal resources of the processor) and each using the protocol PTi and the operating mode Mi of the interface CLINT. Thus, this high level layer is based on the HWML, INTPL and the HCIL according to embodiments of the invention, which are nearly transparent to the APL. The speed of data transfer through the data paths created by the layer HCIL advantageously leads to a substantial increase in the performances of the application layer APL.

The source or destination points P1 and P2 located in the host processors are “services” (determined applications). These services can request the controller NFCC, each independently of the other, to create data paths to simultaneously use the interface CLINT (subject to collisions of modes and protocols, as indicated above). Thus, this software architecture allows a service to be implemented as source or destination points of a data path, and allows several data paths to be simultaneously created between two entities, for example, between two host processors or between a host processor and the contactless data sending/receiving interface.

Similarly, the controller NFCC includes the following software layers. Two layers HWML1 and INTPL in the controller NFCC, are of the same type as the HWML and INTPL present in the host processors. To simplify the diagram, the layers appear in the controller NFCC, but are actually located in the ports INT1 and INT2, which are considered as part of the controller, as well as the buses ADB, DTB, CTB. The processing of the UART and 7816 protocols is performed by the ports INT1, INT2, which place their input and output buffers BUF1, BUF2 at the disposal of the controller NFCC via the buses ADB, DTB, CTB. Another low level HWML2 allows the controller to write to the buffers BUF1 and read the buffers BUF2, via the buses ADB, DTB, CTB, by splitting up the data frames or the commands into data blocks the same size as the buffers. An HCI-ADMIN-L, or protocol administration HCI layer, communicates with the HCIL layers of the host processors HP1, HP2 as routing administrator. Thus, this layer executes the tasks of allocation of data paths described above, and read and write access to the routing table RT via the low level HWML2. A Contactless Interface Control Layer (CLINTCL) manages the interface CLINT and indicates to the latter the required mode Mi and the protocol PTi to use to send data in a contactless communication channel. To that end, the CLINTCL layer exploits the parameters PTi and Mi present in the routing table RT. More particularly, the HCI-ADMIN-L layer writes the parameters in the routing table RT in response to data path opening commands, whereas the CLINTCL layer searches the table RT for these parameters using as an index the channel number of the data frames sent by the host processors HP1, HP2. This layer also controls the interface CLINT in contactless data reception mode and cyclically requests the interface CLINT to scan the modes (reader mode, emulation mode, and device mode) and, in each mode, to search for incoming data. Interface CLINT emits a magnetic field at regular intervals to interrogate possible contactless cards or tags (or other portable objects operating contactless) which may be present in its interrogation field. The interface CLINT also places itself in a listening mode (emulation mode) at regular intervals to detect if a reader in active mode sends interrogation messages.

An optional APL manages applications by itself, like the host processors. Some applications can also be undertaken by the NFC component itself. In that case, the communication of data between the controller NFCC and the interface CLINT can be made by passing through the communication channel HCI, if the interface CLINT is equipped with the INTPL, which is the case in the embodiment shown in FIG. 9.

Eventually, the interface CLINT comprises the following software layers. On the controller NFCC side, a low level HWML layer equivalent to the HWML2 of the controller NFCC manages the data buffers BUF1, BUF2 via the buses ADB, DTB, CTB. An HCIL layer (as indicated above) renders the interface CLINT compatible with the protocol HCI and offers more possibilities of implementation of the invention (in particular the fact that the interface CLINT generates the data frames to send to the host processors data received via a contactless communication channel). On the antenna circuit ACT side, a Contactless Protocol Layer (CLPTL) and a Mode Control Layer (MCL) perform the control and processing of the electrical signals applied to the antenna circuit ACT or received by it, to implement operating modes M1, M2, M3 and protocols PT1, PT2, PT3. Between the layers located on the controller side and the layers located on the antenna circuit side, a central high level High Level Service Layer (HLSL) allows several source or destination points Pc to be defined in the interface CLINT, to create several data paths with multiple points P1, P2 in the application layers APL of the host processors HP1, HP2. This high level architecture is optional and multiple points Pc virtually located in the interface CLINT can be managed by the controller NFCC.

It will clearly appear to those skilled in the art that embodiments of the present invention are susceptible of various embodiments. Thus, the invention is not limited to a system having several host processors and an NFC component. It also covers the control of the execution of applications in a system having one host processor only and executing several applications brought to communicate between them.

In addition, it is not essential that the processor HP2 dedicated to application control is secured. Some non-sensitive applications may not require a high security level.

Moreover, the command formats are described here only by way of example. In particular, the bit “T” can be suppressed to obtain 128 routing channels instead of 64 while keeping an 8-bit header field. The format of the routing table is likewise supplied by way of example. The table can be managed dynamically, or statically, or both.

Annex 1 (Integral part of the description)

### A/Examples of Routing Commands

General format

| | Header | | | Parameters |
|---|---|---|---|---|
| Size | 1 bit | 1 bit | 6 bits | 2 or 3 bytes |
| Means or contains | T | L | CCMD | According to command |
| Value | 1 | 0-1 | 0-31 | |

### T=Type

T=1 for a command or an answer to a command
L=length of the field “parameters”: 2 bytes if L=0 or 3 bytes if L=1
CCMD=code of the command or the message
Examples of commands and of answer messages

### Command “Route Creation”:

| | Header | | | Parameters | | | |
|---|---|---|---|---|---|---|---|
| Size | 1 bit | 1 bit | 6 bits | 1 byte | 1 byte | 4 bits | 4 bits |
| Means or | T | L | CCMD | IDsp | IDdp | Mi | PTi |
| contains | | | | | | | |
| Value | 1 | 1 | VAL1 | 0-255 | 0-255 | 0-15 | 0-15 |

VAL1=value of the command code
IDsp=Identifier of the source point of the command
IDdp=Identifier of the destination point of the route
Mi=operating mode of the contactless data sending/receiving interface (M1, M2 or M3)
PTi=contactless communication protocol (PT1, PT2 or PT3)

### Message “Route Creation OK”

| | Header | | | Parameters | | |
|---|---|---|---|---|---|---|
| Size | 1 bit | 1 bit | 6 bits | 1 byte | 6 bits | 2 bits |
| Means or contains | T | L | CCMD | IDsp | CHANi | RFU |
| Value | 1 | 0 | VAL2 | 0-255 | 0-63 | 0-3 |

VAL2=value of the answer code
IDsp=Identifier of the source point of the command
CHANi=Number of the allotted route (Channel Number)
RFU=Reserved for future use

### Message “Route Creation Error”

| | Header | | | Parameters | |
|---|---|---|---|---|---|
| Size | 1 bit | 1 bit | 6 bits | 1 byte | 1 byte |
| Means or contains | T | L | CCMD | IDsp | IDdp |
| Value | 1 | 0 | VAL3 | 0-255 | 0-255 |

VAL3=value of the message code
IDsp=Identifier of the source point of the command
IDdp=Identifier of the destination point of the route
Mi operating mode of the contactless data sending/receiving interface (M1, M2 or M3)
PTi=contactless communication protocol (PT1, PT2 or PT3)

### Command “Route Modification” or “Route Suppression”

| | Header | | | Parameters | | | | |
|---|---|---|---|---|---|---|---|---|
| Size | 1 bit | 1 bit | 6 bits | 1 byte | 6 bits | 2 bits | 4 bits | 4 bits |
| Means or contains | T | L | CCMD | IDsp | CHANi | RFU | Mi | PTi |
| Value | 1 | 1 | VAL4 or | 0-255 | 0-63 | 0-3 | 0-15 | 0-15 |
| | | | VAL5 | | | | | |

VAL4 or VAL5=value of the code of each command
IDsp=Identifier of the source point of the command
CHANi=Number of the route to modify or suppress
RFU=Reserved for future use
Mi=operating mode of the contactless data sending/receiving interface (M1, M2 or M3)
PTi=contactless communication protocol (PT1, PT2 or PT3)

### Messages “Route Modification OK” or “Route Suppression OK”

| | Header | | | Parameters | | |
|---|---|---|---|---|---|---|
| Size | 1 bit | 1 bit | 6 bits | 1 byte | 6 bits | 2 bits |
| Means or | T | L | CCMD | IDsp | CHANi | RFU |
| contains | | | | | | |
| Value | 1 | 0 | VAL6 or | 0-255 | 0-63 | 0-3 |
| | | | VAL7 | | | |

VAL6 or VAL 7=value of the code of each message
IDsp=Identifier of the source point of the command
CHANi=Number of the route modified or suppressed
RFU=Reserved for future use

### Messages “Route Modification Error” or “Route Suppression Error”

| | Header | | | Parameters | | |
|---|---|---|---|---|---|---|
| Size | 1 bit | 1 bit | 6 bits | 1 byte | 6 bits | 2 bits |
| Means or contains | T | L | CCMD | IDsp | CHANi | RFU |
| Value | 1 | 0 | VAL8 or | 0-255 | 0-63 | 0-3 |
| | | | VAL9 | | | |

VAL8 or VAL 9=value of the code of each message
IDsp=Identifier of the source point of the command
CHANi=Number of the route concerned
RFU=Reserved for future use

### B/Examples of Data Frames

T=0 for a data frame or an answer to a data frame
L=0 if frame of 256 bytes of data
L=1 if frame of 64 Kbytes of data
DL=Length of data in bytes
DATA=Application data
CHANi=Routing channel number

### Frame of 255 Bytes of Data

| | Header | | | | |
|---|---|---|---|---|---|
| Size | 1 bit | 1 bit | 6 bits | 1 byte | 0 to 255 bytes |
| Means or | T | L | CHANi | DL | DATA |
| contains | | | | | |
| Value | 0 | 0 | 0-63 | 255 | |

### Frame of 64K Bytes of Data

| | Header | | | | |
|---|---|---|---|---|---|
| Size | 1 bit | 1 bit | 6 bits | 2 bytes | 0 to 65535 bytes |
| Means or | T | L | CHANi | DL | DATA |
| contains | | | | | |
| Value | 0 | 1 | 0-63 | 65535 | |

Message “Acknowledgement of Receipt without Error”

| Size | 1 bit | 1 bit | 6 bits |
|---|---|---|---|
| Means or contains | T | No error | CHANi |
| Value | 0 | 0 | 0-63 |

### Message “Reception Error”

| Size | 1 bit | 1 bit | 6 bits | 1 byte |
|---|---|---|---|---|
| Means or | T | Error | CHANi | Code of the error |
| contains | | | | |
| Value | 0 | 1 | 0-63 | 0-255 |

### Annex 2 (Integral Part of the Description)

### Examples of Routing Tables

TABLE 1
Example of dynamic routing table with source points located in HP1 or HP2

| | | | | IDdp | | |
|---|---|---|---|---|---|---|
| CHANi | IDsp | PTi | Mi | Send | Notify | Comments |
| 1 | ID(P1) | PT1 | M1 | ID(Pc) | ID(P2) | Processor HP1 to interface CLINT in reader mode ISOA |
| 2 | ID(P1) | PT2 | M1 | ID(Pc) | — | Processor HP1 to interface CLINT in reader mode ISOB |
| 3 | ID(P1) | PT3 | M1 | ID(Pc) | — | Processor HP1 to interface CLINT in reader mode ISO15 |
| 4 | ID(P1) | PT1 | M3 | ID(Pc) | ID(P2) | Processor HP1 to interface CLINT in device mode ISOA |
| 5 | ID(P1) | PT2 | M3 | ID(Pc) | — | Processor HP1 to interface CLINT in device mode ISOB |
| 6 | ID(P1) | PT3 | M3 | ID(Pc) | — | Processor HP1 to interface CLINT in device mode ISO15 |
| 7 | ID(P1) | — | — | ID(P2) | | Processor HP1 to SIM card (HP2) |
| 8 | ID(P2) | — | — | ID(P1) | — | SIM card (HP2) to processor HP1 |
| 9 | ID(P2) | PT1 | M1 | ID(Pc) | — | SIM card (HP2) to interface CLINT in reader mode ISOA |
| 10 | ID(P2) | PT2 | M1 | ID(Pc) | ID(P2) | SIM card (HP2) to interface CLINT in reader mode ISOB |
| 11 | ID(P2) | PT3 | M1 | ID(Pc) | ID(P2) | SIM card (HP2) to interface CLINT in reader mode ISO15 |
| 12 | ID(P2) | PT1 | M3 | ID(Pc) | — | SIM card (HP2) to interface CLINT in device mode ISOA |
| 13 | ID(P2) | PT2 | M3 | ID(Pc) | ID(P2) | SIM card (HP2) to interface CLINT in device mode ISOB |
| 14 | ID(P2) | PT3 | M3 | ID(Pc) | ID(P2) | SIM card (HP2) to interface CLINT in device mode ISO15 |

TABLE 2
Example of prestored routing table with sources points located in HP1 or HP2

| | | | | IDdp | | | | |
|---|---|---|---|---|---|---|---|---|
| CHANi | IDsp | PTi | Mi | Send | Notify | Open | Closed | Comments |
| 1 | ID(P1) | PT1 | M1 | ID(Pc) | ID(P2) | | 1 | Processor HP1 to interface CLINT in reader mode ISOA |
| 2 | ID(P1) | PT2 | M1 | ID(Pc) | — | | 0 | Processor HP1 to interface CLINT in reader mode ISOB |
| 3 | ID(P1) | PT3 | M1 | ID(Pc) | — | | 0 | Processor HP1 to interface CLINT in reader mode ISO15 |
| 4 | ID(P1) | PT1 | M3 | ID(Pc) | ID(P2) | | 0 | Processor HP1 to interface CLINT in device mode ISOA |
| 5 | ID(P1) | PT2 | M3 | ID(Pc) | — | | 0 | Processor HP1 to interface CLINT in device mode ISOB |
| 6 | ID(P1) | PT3 | M3 | ID(Pc) | — | | 0 | Processor HP1 to interface CLINT in device mode ISO15 |
| 7 | ID(P1) | — | — | ID(Pc) | | | 1 | Processor HP1 to SIM card (HP2) |
| 8 | ID(P2) | — | — | ID(P1) | — | | 0 | SIM card (HP2) to processor HP1 |
| 9 | ID(P2) | PT1 | M1 | ID(Pc) | — | | 0 | SIM card (HP2) to interface CLINT in reader mode ISOA |
| 10 | ID(P2) | PT2 | M1 | ID(Pc) | ID(P2) | | 0 | SIM card (HP2) to interface CLINT in reader mode ISOB |
| 11 | ID(P2) | PT3 | M1 | ID(Pc) | ID(P2) | | 0 | SIM card (HP2) to interface CLINT in reader mode ISO15 |
| 12 | ID(P2) | PT1 | M3 | ID(Pc) | — | | 1 | SIM card (HP2) to interface CLINT in device mode ISOA |
| 13 | ID(P2) | PT2 | M3 | ID(Pc) | ID(P2) | | 0 | SIM card (HP2) to interface CLINT in device mode ISOB |
| 14 | ID(P2) | PT3 | M3 | ID(Pc) | ID(P2) | | 0 | SIM card (HP2) to interface CLINT in device mode ISO15 |

TABLE 3
Example of dynamic routing table with a source point located in the interface CLINT and without implementing
the second aspect of the invention (all the data are sent to both host processors HP1, HP2)

| CHANi | IDsp | PTi | Mi | IDdp | | Comments |
|---|---|---|---|---|---|---|
| 40 | ID(Pc) | PT1 | M1 | ID(P1) | ID(P2) | Interface CLINT in reader mode ISO A to processors HP1, HP2 |
| 41 | ID(Pc) | PT2 | M1 | ID(P1) | ID(P2) | Interface CLINT in reader mode ISO B to processors HP1, HP2 |
| 42 | ID(Pc) | PT3 | M1 | ID(P1) | ID(P2) | Interface CLINT in reader mode ISO 15693 to processors HP1, HP2 |
| 43 | ID(Pc) | PT1 | M2 | ID(P2) | ID(P2) | Interface CLINT in emulation mode ISO A to processors HP1, HP2 |
| 44 | ID(Pc) | PT2 | M2 | ID(P1) | ID(P2) | Interface CLINT in emulation mode ISO B to processors HP1, HP2 |
| 45 | ID(Pc) | PT3 | M2 | ID(P1) | ID(P2) | Interface CLINT in emulation mode ISO 15693 to processors HP1, HP2 |
| 46 | ID(Pc) | PT1 | M3 | ID(P1) | ID(P2) | Interface CLINT in device mode ISO A to processors HP1, HP2 |
| 47 | ID(Pc) | PT2 | M3 | ID(P1) | ID(P2) | Interface CLINT in device mode ISO B to processors HP1, HP2 |
| 48 | ID(Pc) | PT3 | M3 | ID(P1) | ID(P2) | Interface CLINT in device mode ISO 15693 to processors HP1, HP2 |

TABLE 4
Example of prestored routing table having a source point located in the interface CLINT (second aspect of the invention)

| | | | | IDdp | | | | |
|---|---|---|---|---|---|---|---|---|
| CHANi | IDsp | PTi | Mi | Send | Notify | Open | Used | Comments |
| 40 | ID(Pc) | PT1 | M1 | ID(P1) | ID(P2) | | | Interface CLINT in reader mode ISO A to processor HP1 |
| 41 | ID(Pc) | PT2 | M1 | ID(P1) | ID(P2) | | | Interface CLINT in reader mode ISO B to processor HP1 |
| 42 | ID(Pc) | PT3 | M1 | ID(P2) | | | | Interface CLINT in reader mode ISO 15693 to SIM card (HP2) |
| 43 | ID(Pc) | PT1 | M2 | ID(P2) | | | | Interface CLINT in card emulation mode ISO A to SIM card (HP2) |
| 44 | ID(Pc) | PT2 | M2 | ID(P1) | — | | | Interface CLINT in card emulation mode ISO B to processor HP1 |
| 45 | ID(Pc) | PT3 | M2 | — | ID(P2) | | | Interface CLINT in card emulation mode ISO 15693 to SIM card (HP2) |
| | | | | | | | | (notification only) |
| 46 | ID(Pc) | PT1 | M3 | ID(P1) | ID(P2) | | | Device mode ISO A; matching managed by host processor |
| 47 | ID(Pc) | PT2 | M3 | — | — | | | No action (configuration forbidden) |
| 48 | ID(Pc) | PT3 | M3 | ID(P1) | ID(P2) | | | Device mode ISO 15693; matching managed by host processor |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-30. (canceled)

31. A method for controlling the execution of an application in a system having a contactless data sending/receiving interface of Near Field Communication type, wherein control of the execution of the application is based on control of a data path internal to the system, the data path being configured to transfer data of the application, the method comprising:
in response to a request for using the data path in a non-open state, emitted by a source point and designating a destination point, requesting the authorization to open the data path to an application control function; and
opening the data path to allow the application to be executed if the application control function authorizes the opening of the data path.

32. The method of claim 1, wherein the application control function is executed by a first host processor.

33. The method of claim 2, wherein the first host processor is a secured circuit.

34. The method of claim 2, wherein the first host processor is an integrated circuit of a subscriber identity module (SIM) card.

35. The method of claim 3, wherein the application is executed by at least one second host processor.

36. The method of claim 1, further comprising authenticating the application control function prior to the step of requesting authorization, the opening of the data path not being authorized if the application control function has not been authenticated.

37. The method of claim 6, further comprising supplying to the application control function a session key used to cipher data exchanged with the application control function if the application control function has been authenticated.

38. The method of claim 1, further comprising authenticating, by the application control function, the source point that has emitted the request for using the data path, the application control function authorizing the opening of the data path only if the source point is authenticated.

39. The method of claim 8, wherein the authentication of the source point includes checking a certificate supplied by a certification authority to a host processor in which the source point to be authenticated is located.

40. The method of claim 1, wherein opening of the data path includes:
allocating a routing channel number to the data path, and storing the routing channel number and routing parameters including at least one identifier of the source point and one identifier of the destination point;
sending, to the destination point, data supplied by the source point by encapsulating the data in a frame having a header field including the routing channel number; and
upon receipt transmitting the data toward the data destination point corresponding to the identifier of the stored destination point.

41. The method of claim 10, wherein the application control function authorizes or denies the opening of a data path according to the routing parameters of the data path to be opened.

42. The method of claim 1, wherein the sending/receiving interface is configurable according to a predetermined number of operating modes and according to a predetermined number of contactless communication protocols, the application control function authorizing or denying the opening of the data path according to the operating mode and the communication protocol of the data path to be opened.

43. The method of claim 12, further comprising: in response to an authorization for opening the data path between a source point and a destination point located in the contactless data sending/receiving interface, opening a data path between the source point and the sending/receiving interface so that data is emitted in a contactless data transmission channel using the operating mode and the contactless communication protocol parameters stored for the data path through which the data to be emitted was received.

44. The method of claim 1, a plurality of data paths are simultaneously opened, the routing channel number and the routing parameters of each data path opened being stored in a routing table, the method further comprising searching the routing table for a destination point of received data encapsulated in a frame, wherein the routing channel number is an index for selecting the destination point.

45. The method of claim 1, further comprising:
prestoring a plurality of data paths in a routing table, each data path including an identifier of a destination point, an operating mode parameter of the sending/receiving interface, a contactless communication protocol parameter, and a data path open/closed indicator; and
when data is received by the sending/receiving interface via a contactless data transmission channel, determining at least one data destination point by searching the routing table for an open data path having an operating mode parameter and a contactless communication protocol parameter corresponding to the operating mode and contactless communication protocol parameters used by the sending/receiving interface to create the contactless data transmission channel through which the data was received.

46. A device for controlling the execution of an application in a system comprising:
a contactless data sending/receiving interface of Near Field Communication type, driven by a controller, wherein control of the execution of the application is based on a control of a data path internal to the system, the data path being configured to transfer data of the application, the controller being configured to:
in response to a request for using the data path in a non-open state, emitted by a source point and designating a destination point, request authorization to open the data path to an application control function; and
open the data path to allow the application to be executed if the application control function authorizes the opening of the data path.

47. The device of claim 16, wherein the system includes at least a first host processor executing the application control function, and at least one input/output port to couple the sending/receiving interface to the first host processor.

48. The device of claim 17, wherein the first host processor executing the application control function is a secured integrated circuit.

49. The device of claims 18, wherein the first host processor executing the application control function is an integrated circuit of a subscriber identity module (SIM) card.

50. The device of claim 18, wherein the system includes at least one second host processor executing the application.

51. The device of claim 16, wherein the controller is configured to authenticate the application control function prior to performing the authorization request, the opening of the data path not being authorized if the application control function has not been authenticated.

52. The device of claim 21, wherein the controller is configured to supply to the application control function a session key used to cipher the data exchanged between the controller and the application control function, if the application control function has been authenticated.

53. The device of claim 16, wherein the controller is configured to transmit authentication data exchanged between the application control function and the source point which has emitted the request for using the data path, the application control function authorizing the opening of the data path only if the authentication has succeeded.

54. The device of claim 23, wherein the authentication data exchanged between the application control function and the source point which has emitted the request for using the data path includes a certificate supplied by a certification authority to a host processor in which the source point to be authenticated is located.

55. The device of claim 16, wherein the controller is further configured to:
allot a routing channel number to the data path, and store the routing channel number and routing parameters including at least one identifier of the source point and one identifier of the destination point,
send, to the destination point, data supplied by the source point by encapsulating the data in a frame having a header field including the routing channel number, and
upon receipt, transmit the data to the data destination point corresponding to the identifier of the destination point memorized.

56. The device of claim 16, wherein the controller is further configured to authorize or deny the opening of the data path according to the routing parameters of the data path to be opened.

57. The device of claim 16, wherein the contactless data sending/receiving interface is configurable according to a predetermined number of operating modes and according to a predetermined number of contactless communication protocols, the application control function being configured to authorize or deny the opening of the data path according to the operating mode and the communication protocol of the data path to be opened.

58. The device of claim 27, wherein the controller is further configured to, in response to an authorization for opening the data path between the source point and designating a destination point located in the contactless data sending/receiving interface, open the data path between the source point and the destination point by configuring the sending/receiving interface so that data is emitted in a contactless data transmission channel using the operating mode and contactless communication protocol parameters stored for the data path to be opened.

59. The device of claim 16, wherein the controller is further configured to simultaneously open a plurality of data paths, the routing channel number and the routing parameters of each open data path being stored in a routing table, and search the routing table for a destination point of the received data encapsulated in a frame, by using the routing channel number as an index for selecting the destination point.

60. The device of claim 16, wherein a data transmission function is configured to:
prestore data paths in a routing table, each data path including an identifier of a destination point, an operating mode parameter of the sending/receiving interface, a contactless communication protocol parameter, and a data path open/closed indicator, and
when data is received by the sending/receiving interface via a contactless data transmission channel, determine at least one data destination point by searching the routing table for an open data path having an operating mode parameter and a contactless communication protocol parameter corresponding to the operating mode and contactless communication protocol parameters used by the sending/receiving interface to create the contactless data transmission channel through which the data was received.
